(19) United States
(12) Patent Application Publication
(10) Pub. No.: US 2009/0307092 A1
(43) Pub. Date: Dec. 10, 2009

(54) SYSTEM AND METHOD FOR PROVIDING MEDIA CONTENT

(75) Inventors: Charlie Gugliuzza, Ladera Ranch, CA (US); Michael Hill, Santa Barbara, CA (US)

Correspondence Address: TSIRCOU INTELLECTUAL PROPERTY LAW, 655 Central Ave., 17th Floor, Glendale, CA, 91203, US

(73) Assignee: DIONYTECH, INC., Newport Beach, CA (US)

(21) Appl. No.: 12/146,922

(22) Filed: Jun. 26, 2008

Related U.S. Application Data
(60) Provisional application No. 61/058,884, filed on Jun. 4, 2008.

(51) Int. Cl. G06Q 30/00; G06F 3/048; G06F 7/06; G06F 17/30; G06F 15/16

(52) U.S. Cl. 705/14.64; 715/716; 707/3; 709/203; 705/26; 707/E17.014

(57) ABSTRACT

A system and method is provided for providing media content to a client device. The system includes a digital player that delivers time-sequenced advertisement, such as merchandise information displayed in coordination with the content presented by the digital media. The player includes a media panel for presenting the digital media and an advertisement panel for presenting advertisements associated with content currently displayed in the media panel. The player further includes a history panel that lists in sequence advertisements presented in the advertisement panel during the presentation of the media content. In this manner, the player enables the view to access previously presented advertisements at the viewer's convenience.

### CROSS REFERENCE TO RELATED APPLICATION

This application claims the benefit of U.S. Provisional Application No. 61/058,884, filed Jun. 4, 2008, which is herein incorporated by reference.

### FIELD OF THE INVENTION

The present invention relates generally to digital media players and, more particularly, to digital media players configured to provide advertising associated with the content of the digital media played.

### BACKGROUND OF THE INVENTION

Traditionally, media content such as audio and video programming reached consumers through direct transmission means, such as RF transmissions, cable transmissions, and the like. Such media distribution was provided to consumers as a free service in an effort to obtain large audiences of the content. The media providers would obtain revenue by providing commercials interspersed throughout the programming. In the past, this approach was effective in part because the consumer had little ability to manipulate the media stream, and would therefore be effectively exposed to the commercial content, as well as the other media content.

Advances in technology have influenced traditional means of commercializing media content. Consumers now have significantly or control over their exposure to media content. Content can be recorded, played back, and fast-forwarded through with little effort or technical expertise. With the advent of the Internet, consumers are much more accustomed to having a highly interactive experience with their media content. Thus, traditional approaches of interspersing commercials within media content are becoming less effective in generating revenue for content providers.

Moreover, trends indicate that consumers are transitioning away from traditional broadcasts sources as means for receiving media content. Instead, consumers turn to alternative sources available through the Internet, for example. Internet media providers implement various approaches for obtaining revenue, such as use of banner ads or charging fees to consumers. Nonetheless, there is a need for better ways to commercialize the economic value generated from media content.

It should, therefore, be appreciated that there remains a need for system and related method that addresses the aforementioned shortcomings. The present invention fulfills these needs and others.

### SUMMARY OF THE INVENTION

Briefly, and in general terms, the invention provides a computer-implemented system for providing media content comprising a client device having a digital player for playing digital media content. The digital player provides a media panel for presenting media content. The player further provides an advertisement panel and a history panel. The advertising panel presents advertisements having advertisement information presented at prescribed times in relation to media content presented in the media panel. The advertisement history panel lists in sequence advertisements presented in the advertisement panel during the presentation of the media content.

More particularly, and in an exemplary embodiment, the player is configured to communicate with a server via a communications network to access a plurality of digital media files and cue files stored on the server. The player further receives from the server at least one each cue point configured to cause the player to perform time-sequenced actions associated with content of a prescribed media file. The cue point can be either integrated in to the media file or provided by a separate file.

In a detailed aspect of an exemplary embodiment, the player further includes a shopping panel for listing items selected by a user. The system is further configured to process the purchase of an item presented in an advertisement associated with the digital media.

An exemplary method in accordance with the invention includes providing digital media content to digital player on a client device on a media panel of the player for presenting media content; providing cue points within a digital file. The cue points are configured to cause the player to perform time-sequenced actions associated with content of a prescribed media file, such that the cue point cause an advertisement panel of the player to present advertisements at prescribed times in relation to media content presented in the media panel. The method further includes receiving a purchase request selected through the graphical user interface of an item presented in an advertisement associated with the digital media.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein. Moreover, a number of features are discussed throughout the specification with reference to particular embodiments. Nonetheless, those skilled in the art will appreciate that various other embodiments can be provided without departing from the scope of the invention, to include any and all combination of features discussed.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is an exemplary graphical user interface (GUI) for digital media player for a system for providing media content and associated advertising in accordance with the present invention.

FIG. 2 depicts a product review panel deployed on the media player of FIG. 1.

FIG. 3 depicts a shopping cart panel deployed on the media player of FIG. 1.

FIG. 4 depicts a shopping cart panel and check out process for the media player of FIG. 1.

FIG. 5 is a simplified block diagram of a system incorporating the media player of FIG. 1, depicting client devices configured to run the player.

FIG. 6 depicts simplified diagram for media and cue point files used by the media player of FIG. 1, depicting cue points that cause the player to take prescribed actions at times coordinated with the media content.

### DETAILED DESCRIPTION OF THE PREFERRED EMBODIMENTS

Referring now to the drawings, there is shown a system 10 for providing digital media over communications network to viewers. The system includes a digital player 12 that delivers time-sequenced advertisement, such as merchandise information displayed in coordination with the content presented by the digital media. The player includes a graphical user interface (GUI) 14 having a media panel 16 for presenting the digital media and an advertisement panel 18 for presenting advertisements associated with content currently displayed in the media panel. The GUI further includes a history panel 20 that lists in sequence advertisements presented in the advertisement panel during the presentation of the media content. In this manner, the player enables the viewer to access previously presented advertisements at the viewer's convenience.

The player 12 enables viewers to access advertising information regarding items displayed during the course of a viewing. For example, if a scene being displayed shows a man wearing a suit, the advertisement panel 18 could display information about the suit that is worn, such as brand, style, and price. The advertisement information could include text, images, and digital video. The advertisements are time-sequenced to be displayed in coordination with the content presented in the media panel 16. In addition, the duration of the advertisement displayed can be tailored. For example, the advertisement can coordinated such that it is display for the same duration an item is displayed in the media content. Alternatively, the advertisement can be programming to run for a varied duration, as desired. It might be desirable to keep the advertisement up for additional time to allowing users additional time to review the information.

The player 12 further includes a shopping list panel 22 disposed adjacent to the media panel 16. The player enables viewers to place items in the shopping list for further review and purchase. For example, a viewer can select an item from the advertisement panel 18 by select the “Add to Shopping List” icon 24. In addition, a viewer can select an item by selecting an icon 26 from the history panel 20 to add the item to the shopping list. Thus, viewers can maintain a list of items that they would like to review in further detail. Viewers can review items within the shopping list for additional detail by selecting the “View Shopping List” button 28 located in the shopping list panel 22, which pauses playback of the media file and launches a window for depicting items of the shopping list.

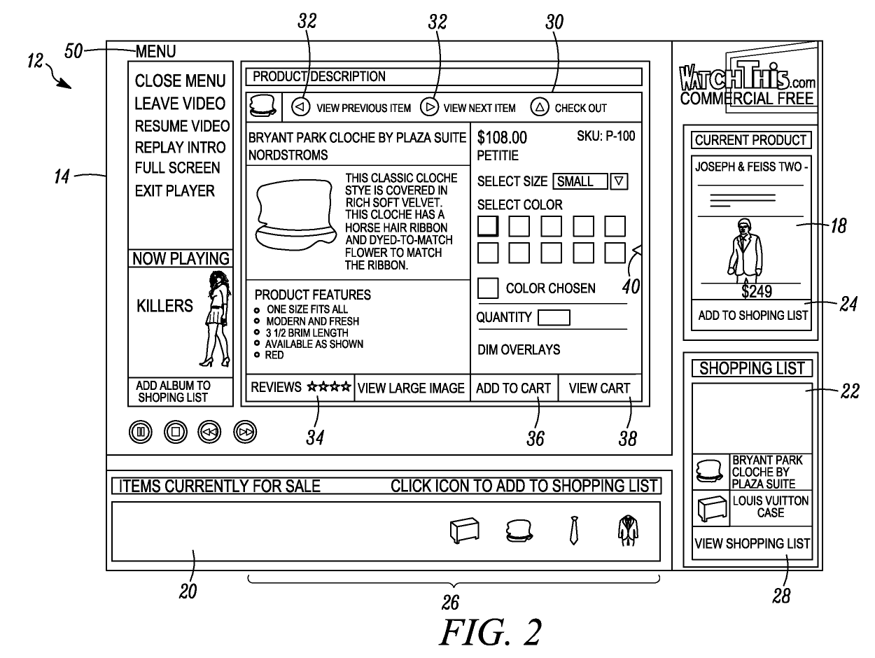

With reference now to FIG. 2, the player 12 enables viewers to review additional detail for items within the shopping list. The player presents a review window 30 disposed over the media panel 16. The viewer can scroll through the items in the shopping list by using scrolling buttons 32 in the upper portion of the review window, or by selecting the icons within the shopping list panel 22.

The review window 30 provides images and text describing the item and additional detail to include product description, size and color availability, and price. In addition, reviews regarding the particular item can be accessed by selecting a “Reviews” button 34. Viewers can purchase the item directly through the player. To that end, the review window enables users to review purchase prize select size, select color, and quantity. Once these selections are made to viewer adds the item to the shopping cart by selecting “Add to Cart” 36. Items selected for purchase with the shopping cart can be viewed by selecting the “View Cart” button 38 or by selecting the arrow icon 40 along the left side of the review panel

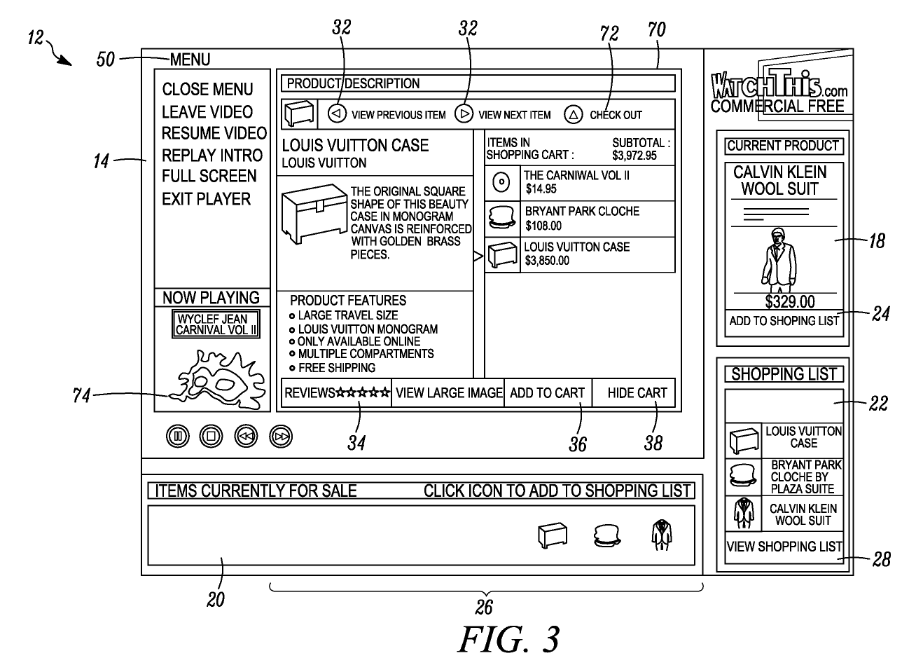

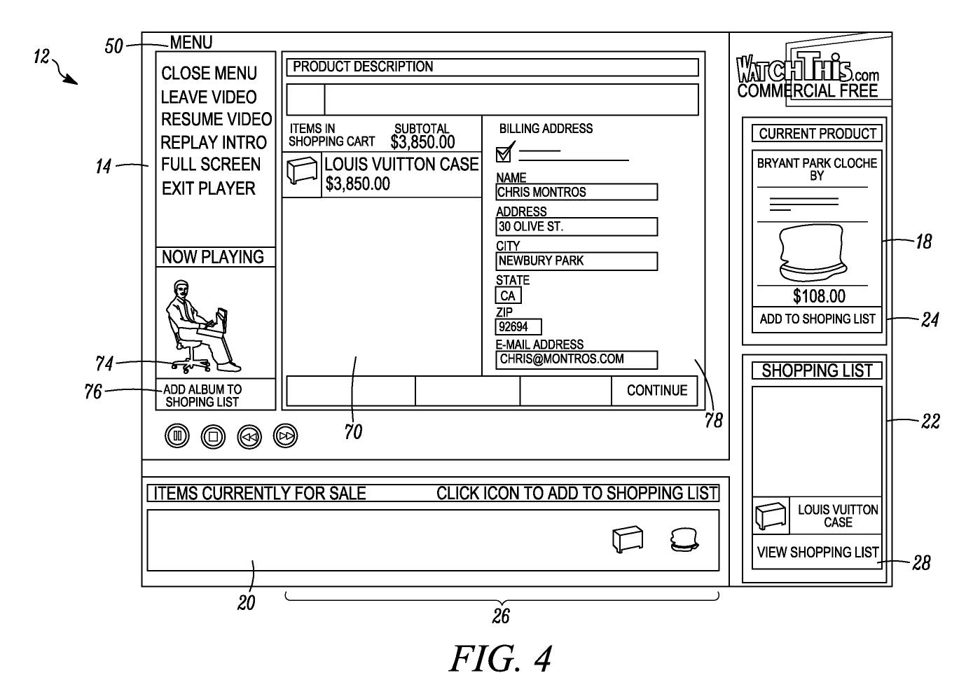

With reference now to FIGS. 3 and 4, the player 12 lists items selected for purchase by the viewer in a shopping cart panel 70. The viewer can complete the purchase by selecting the “Check Out” button 72, which initiates the check out process. The player will capture shipping and billing information 78 (FIG. 4.) from the viewer, e.g., credit card information. Alternatively, the system allows viewers to have such information saved within a database of the system to expedite the purchase process. The player transmits the purchase information to a server and database of the system to finalize processing of the order. Thus, viewers can purchase items in a convenience manner using the player.

The player 12 further provides cross sell and additional advertisement opportunities during the product review and check out process. For example, the player is configured to play music while the viewer reviews products and proceeds with check out. To that end, the player provides a depiction of the album cover or other icon (74) representing the music played. The view can add the music album to the shopping cart for purchase by selecting “Add Album to Shopping List” button 76 or by selecting the album icon 74.

Whenever a user selects an icon to view additional detail or add an item to their shopping list, the system 10 can track this information to help build a history as to the user's interests. Information tracked could include items placed in the shopping list but not purchased, items purchased, items viewed, and selections along the storyline, as discussed above. As a result, the system can tailor content and advertisements to a particular user's interests.

With reference now to FIGS. 5 and 6, there is shown a simplified block diagram of the system 10, having a plurality of components in communication with one another via a communications network 42 (e.g., the Internet), including client devices 44, system server 46 and database 48. Connections between components are shown using double-sided arrows, which may be physical, fiber optic, wireless, or any other type of communications link.

The client devices 44 can include any of various electronic devices, such as personal computers, laptops, cellular phones, personal digital assistants, and so on, that users can use to connect via the communications network, and can further include those devices that can utilize scripted instructions.

The server 46 stores and runs prescribed applications of the system 10 and is connected to the communications network 42 through a communications device. Multiple servers may be included to accommodate high-volume demand on the system. The server runs applications that direct data and information for use by the player 12, such as processing orders from the shopping cart function of the player.

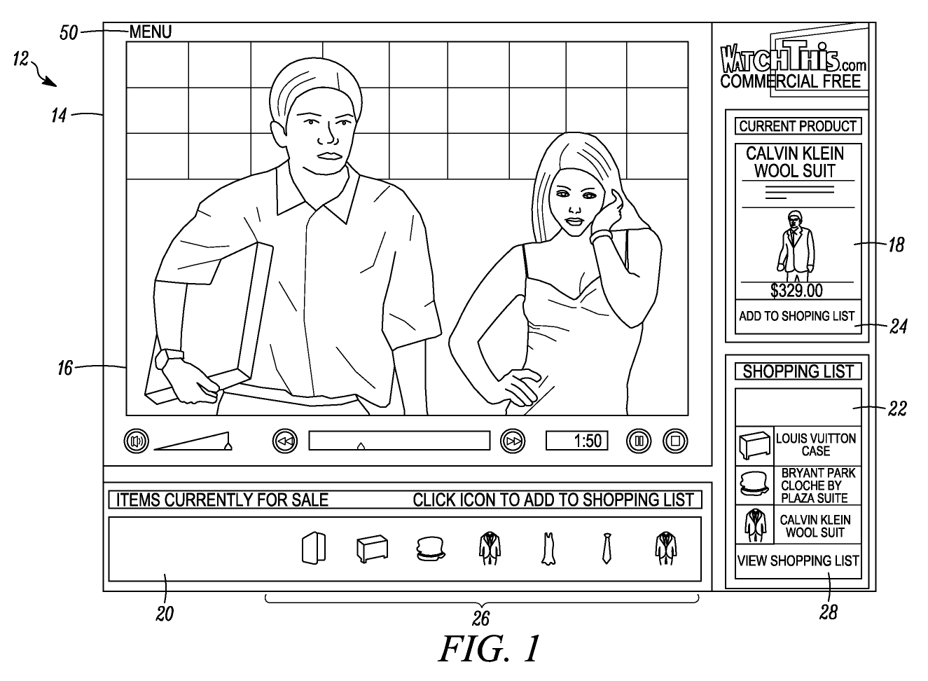

The player 12 is configured to provide viewers with a wide variety of video programs for viewing. In the exemplary embodiment, the player 12 of the system runs on the client device 44 and the media files are stored on in the database of the server 46. In use, the player queries the database 48 to determine the videos that are available for viewing. The player includes a menu 50 (FIG. 1) accessible by the viewer for listing the available videos. In the exemplary embodiment, the menu lists the videos by genre, shows, and episodes.

Once a video selected for viewing, the player 12 communicates with the server 46 to initiate streaming of the video file. In other embodiment, the video file can also be preloaded. The player is configured to play video and audio files. In the exemplary embodiment, digital content is presented in Flash® format as is known in the art, although other digital formats can be used without departing from the invention.

In addition, the player 12 receives a cue file 56 containing cue points 58 associated with the selected video. As the video is played, each cue point causes the player to initiate action at the prescribed time in the video playback. Each cue point includes timing information coordinated with the video file as well as actions to be performed at that time. In the exemplary embodiment, the cue points cause the player to present the advertising information in the product of panel. More particularly, the player loads content received from the server such as images and text for display in the product panel. In addition, an icon associated with a particular product is placed in the history panel.

The various files, images, icon and so on associated with each action of the cue file 56 can be pre-stored on the server 46 or on the client device 44. In the exemplary embodiment, the player 12 preloads all files required by a cue file from the server to the client device. As the video plays, the player loads the files and performs the actions identified in accordance with the timing and sequence set forth in the cue file. The player can be configured to maintain such files in a temporary manner on the client device, to preserve digital memory of the client device.

In the exemplary embodiment, a single cue file 56 is used, which is preloaded prior streaming of the video file; however, various other approaches for loading cue points can be used without departing from the invention. For example, each cue point can be loaded at prescribed times during the play of the video. In addition, a first cue point could be pre-loaded. Once that cue point is activated, an action could include loading a subsequent cue point. In other embodiments, various other actions can be initiated by the use of the cue points 58. Alternatively, cue points can be integrated into the video file itself, e.g., using metadata, and so on.

In an exemplary method of use, the system can enable creation of new programs tailor to take advantage of features provided by the system. For example, cue points could be used to provide viewers with a more interactive experience with the storyline presented. At prescribed points with in a particular story, cue points could be used to query the user as to which aspect of the story the user might want to follow. A cue point could initiate presentation of a dialog box requiring the user to select from prescribed options for the storyline. For example, the story might have two characters separating at the end of the conversation. A cue point could be used at this point to query the user as to which character the viewer would like to follow in the storyline. If the viewer chooses Character A, then the player would load a subsequent video file depicting the storyline for Character A. Alternatively, if the viewer chooses character B, then the player would load of video file depicting the storyline for Character B.

In another exemplary method of use, the system 10 is further configured present users with surveys, such as those directed to the content presented in a video. Such surveys can be configured to receive feedback from the viewers that can be used to tailor upcoming episodes of a particular program or series to storylines or other features that are of interest to the viewers. For example, surveys can query viewers to identify favorite characters or storylines of a series. Responses to the surveys are saved in the database 48 for review by content managers. In addition, survey results can be utilized across various programs to assess general interests of the audience, among other things. Such information can be utilized by content managers for development of upcoming episodes for particular series as well as development of new programming. In addition, such information can be useful for advertisers, such that they can target desirable demographics.

In yet another an exemplary method of use, the system 10 tailored to play older, syndicated television series and to present advertising associated with that program. Over a period of time, the system can track detailed information regarding viewers of the program and associated actions taken in association with the program. For example, information can be collected regarding the types of items reviewed and/or purchased. In addition, demographic information can be tracked. This information can be used to tailor future advertisements and items presented with episodes of the series.

In other embodiments, the system can be configured such that viewer can select items within the media image for product review and purchase. For example, if a viewer would like information on an item depicted within the media, the viewer could select the items, e.g., by selecting with a cursor and mouse, or via infrared selection or utilizing other means known in the art. To that end, the system can provide an object mapping, overlays, or other means to track items within the media content, enabling the system to distinguish among the items depicted within a scene. Once an item is selected, it can be added to the shopping list and/or presented to the viewer through a product review function, such as those discussed above.

In the exemplary embodiment, advertisements presented and items offered for sale correspond to specific items within the content of the media presented by the player. However, in other embodiments, and advertisements and items offered for sale need not correspond directly to specific items within the media. Rather, advertisements and items for sale can be provided for similar or complementary items and services. For example, if the video depicts a suitcase, advertisements for a suitcase from another provider can be presented and offered for sale in the advertisement panel, as discussed above. Moreover, advertisements could also be presented that related more generally to travel, such as airline ads or offers.

In addition, multiple items can be presented on a comparative or competitive basis. For example, if a suitcase is shown, various different suitcases for the same brand, or even from various different brands, can be presented to the viewer through the player 12.

It should be appreciated from the foregoing that the present invention provides a system for providing digital media over communications network to viewers. The system includes a digital player that delivers time-sequenced advertisement, such as merchandise information displayed in coordination with the content presented by the digital media. The player includes a media panel for presenting the digital media and an advertisement panel for presenting advertisements associated with content currently displayed in the media panel. The player further includes a history panel that lists in sequence advertisements presented in the advertisement panel during the presentation of the media content. In this manner, the player enables the view to access previously presented advertisements at the viewer's convenience. Although the invention has been disclosed in detail with reference only to the exemplary embodiments, those skilled in the art will appreciate that various other embodiments can be provided without departing from the scope of the invention, to include any and all combination of features discussed. Accordingly, the invention is defined only by the claims set forth below.

What is claimed is:

1. A computer-implemented system for providing media content, comprising:
a client device having a digital player for playing digital media content, the digital player having a media panel for presenting media content, an advertisement panel for presenting advertisements at prescribed times in relation to media content presented in the media panel, and an advertisement history panel for listing in sequence advertisements presented in the advertisement panel during the presentation of the media content.

2. A system as defined in claim 1, wherein the player is configured to communicate with a server via a communications network to access a plurality of digital media files and cue files stored on the server, each cue file configured to cause the player to perform time-sequenced actions associated with content of a prescribed media file.

3. A system as defined in claim 1, wherein the player is configured to communicate with a server via a communications network to access a plurality of digital media files stored on the server, wherein the player further receives from the server at least one each cue point configured to cause the player to perform time sequenced actions associated with content of a prescribed media file, wherein further the cue point is either integrated in to the media file or provided by a separate file.

4. A system as defined in claim 1, wherein the player further includes a shopping panel for listing items selected by a user.

5. A system as defined in claim 1, wherein the media panel, the advertisement panel, and the advertisement history panel are disposed in spaced relationship to one another.

6. A system as defined in claim 1, wherein the player further includes an electronic shopping cart configured to enable viewer to purchase items associated with advertisements presented in the advertisement panel.

7. A computer-implemented method for providing for media content, comprising:
providing digital media content to digital player on a client device, the digital player having a media panel for presenting media content, an advertisement panel for presenting advertisements at prescribed times in relation to media content presented in the media panel, and an advertisement history panel for listing in sequence advertisements presented in the advertisement panel during the presentation of the media content; and
receiving a purchase request selected through the graphical user interface of an item presented in an advertisement associated with the digital media.

8. A method as defined in claim 7, wherein the player further includes a shopping panel for listing items selected by a viewer.

9. A method as defined in claim 7, wherein an advertisement presented makes an item available for purchase that corresponds to an item displayed in the media content such that a viewer.

10. A method as defined in claim 7, wherein the history panel displays the advertisement icons in the order in which they are presented during the course of presenting the media content.

11. A method as defined in claim 7, wherein selection of an advertisement icon in the history panel places an associated item into an electronic shopping cart of the player.

12. A method as defined in claim 7, wherein the digital media content is provided from a server to the client device over a communications network, the server providing the client device with access a plurality of digital media files.

13. A computer-implemented method for providing for media content, comprising:
providing digital media content to digital player on a client device, the digital player having a media panel for presenting media content;
providing cue points within a digital file, the cue points configured to cause the player to perform time-sequenced actions associated with content of a prescribed media file, such that the cue point cause an advertisement panel of the player to present advertisements at prescribed times in relation to media content presented in the media panel; and
receiving a purchase request selected through the graphical user interface of an item presented in an advertisement associated with the digital media.

14. A method as defined in claim 12, wherein the cue points and the digital media content are provided in separate files.

15. A method as defined in claim 12, wherein the cue points are configured to cause the player to query a viewer to select from a plurality of options associated with a storyline of the media content such that the option selected by the viewer causes a subsequent media file to play associated with the option selected.

16. A method as defined in claim 12, wherein the player further includes a shopping panel for listing items selected by a viewer.

17. A method as defined in claim 15, wherein the media panel, the advertisement panel, and the advertisement history panel are disposed in spaced relationship to one another.

18. A method as defined in claim 16, wherein the history panel displays the advertisement icons in the order in which they are presented during the course of presenting the media content.

19. A method as defined in claim 17, wherein selection of an advertisement icon in the history panel places an associated item into an electronic shopping cart of the player.
